(19) United States
(12) Patent Application Publication
(10) Pub. No.: US 2014/0077665 A1
(43) Pub. Date: Mar. 20, 2014

(54) REMOVABLE WOUND STATOR FOR INTEGRATED MOTOR/COMPRESSOR

(71) Applicants: Mark John DeBlock, Peterborough (CA); Neil Pewtner, Ennismore (CA); Graham Thomas Charles Wheeler, Lakefield (CA)

(72) Inventors: Mark John DeBlock, Peterborough (CA); Neil Pewtner, Ennismore (CA); Graham Thomas Charles Wheeler, Lakefield (CA)

(73) Assignee: General Electric Company, Schenectady, NY (US)

(21) Appl. No.: 13/616,353

(22) Filed: Sep. 14, 2012

(51) Int. Cl. H02K 5/00

(52) U.S. Cl. 310/418

(57) ABSTRACT

A pressurized gas cooled high speed motor includes a wound stator and rotor assembly disposed within a pressure vessel such that the stator and rotor assembly can be removed without disconnecting the high pressure lines to the pressure vessel. The stator has a spring loaded axial retention mechanism that cooperates with a concentric groove in the pressure vessel for maintaining the stator and rotor assembly fixedly in place in the pressure vessel during transport and operation of the motor. A shoulder formed in the pressure vessel is used to axially position the stator assembly within the pressure vessel. A key if provided for angularly and fixedly positioning the stator within the pressure vessel.

### FIELD OF TECHNOLOGY

The invention is directed to pressurized gas cooled motors which directly drive a centrifugal compressor and, more particularly, to a wound stator design for such motors that can be removed from the motor enclosure (pressure vessel). The invention further involves a stator arrangement that facilitates removal of the stator and rotor, simultaneously.

### BACKGROUND

Removable stators have been proposed for conventional motor designs. For example, it is known to axially position a removable stator using chamfered centering rings provided in the stator and clamped between mating chamfered shoulders provided in the motor casing and a clamping ring. In addition to requiring accurate centering, such an arrangement does not provide a significant allowance for relative thermal expansion that occurs in pressurized gas cooled motor assemblies.

It has also been proposed to position a removable stator axially and retain the stator in position both angularly and elastically using a wave spring. Such an arrangement includes centering and clamping by using centering rings provided in the stator in addition to a series of offset recesses in the casing used for angular positioning by engaging the spring. As such this arrangement also does not provide a significant allowance for relative thermal expansion that occurs in pressurized gas cooled motor assemblies.

### SUMMARY

It is desirable to have the ability to replace a wound stator in an integrated compressor assembly without disconnecting high pressure piping from the motor enclosure or pressure vessel. In such high pressure, integrated compressor assemblies it would be advantageous to be able to provide spare stators for easy replacement of failed stators.

In the exemplary embodiments disclosed in detail hereafter it is now proposed to use a pressurized gas cooled integrated motor-compressor unit which allows for removal of the stator core alone or simultaneously with the rotor without the need to disconnect the high pressure piping. The wound stator fits to the pressure vessel utilizing a small diametrical clearance which facilitates assembly and disassembly.

In an exemplary embodiment, an original spring loaded axial retention mechanism is disposed within a concentric groove made for this purpose in the thick-walled pressure vessel that serves as a motor enclosure. Mechanisms for the positioning and retention of the removable stator include: a shoulder provided in the pressure vessel for axial positioning and a key system for angular positioning and retention which are suitably sized to bear the torque.

More particularly, the wound stator is located axially by the shoulder in the pressure vessel. The spring loaded axial retention mechanism produces an axial force sufficient to restrain the stator from movement under operational and fault torques, and further serves to restrain the stator during transport. The spring loaded mechanism has enough axial movement to accommodate the differential thermal growth of the stator with respect to the pressure vessel during operation.

The key system maintains the angular location of the wound stator within the pressure vessel so that it does not turn or rotate through any appreciable angle within the pressure vessel during transport or under operating conditions.

The diametrical clearance is selected to minimize the eccentricity of the stator to the rotor and, therefore, limit unbalanced magnetic forces. The diametrical clearance is sufficiently large to prevent the thermal expansion of the stator from imposing excessive stresses on the pressure vessel. Tooling is provided to assist in the assembly and disassembly of the wound stator (and rotor) to and from the pressure vessel.

In accordance with the exemplary embodiments described herein the wound stator of an electric motor can be removed from the pressure vessel for service or replacement. Should an original wound stator require service, a spare wound stator can replace the original and allow the customer to keep the motor/compressor assembly in service and production.

### BRIEF DESCRIPTION OF THE DRAWINGS

FIG. 1 shows an exemplary embodiment of a pressurized gas cooled integrated motor-compressor unit;

FIG. 2 is a perspective view of the wound stator core including connection rings and wiring connectors;

FIG. 3 is a cross sectional view of the stator assembly within the pressure vessel according to the exemplary embodiment of FIG. 1;

FIG. 4 shows in greater detail the rollers at the bottom of the stator core assembly shown in FIG. 3 for facilitating insertion and removal of the stator core in the pressure vessel;

FIG. 5 shows in perspective the rollers at the bottom of the stator core assembly;

FIG. 6 shows in greater detail portions of the stator assembly of FIG. 3;

FIG. 7 shows in greater detail the tooling for inserting and removing the stator core assembly from the pressure vessel;

FIG. 8 shows a cross sectional view of the key system for fixing the angular position of the stator assembly within the pressure vessel; and

FIG. 9 shows a longitudinal cross section view of the key system in FIG. 8.

### DETAILED DESCRIPTION

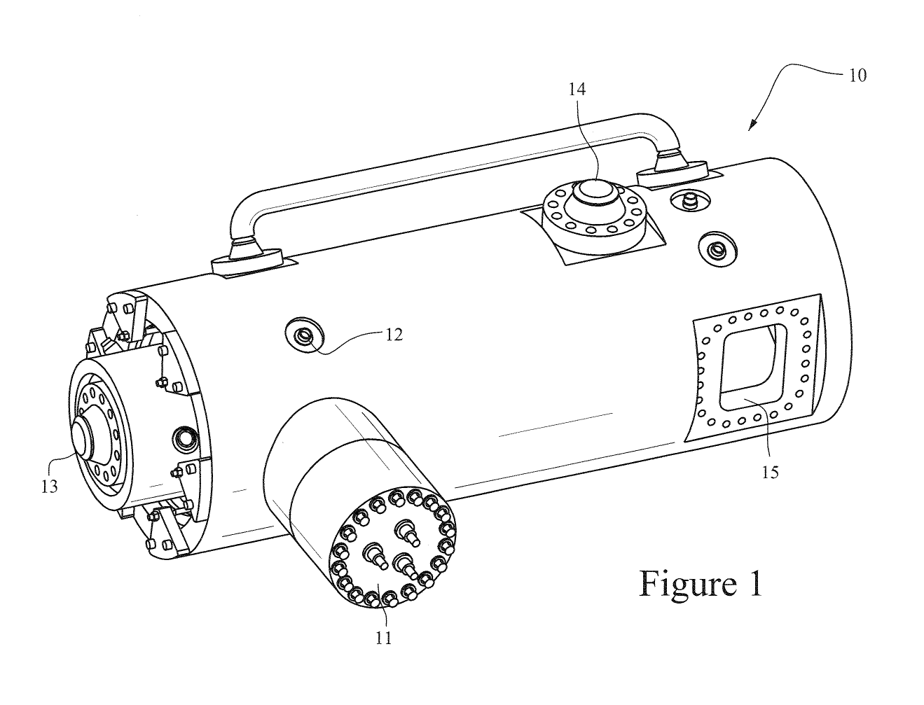

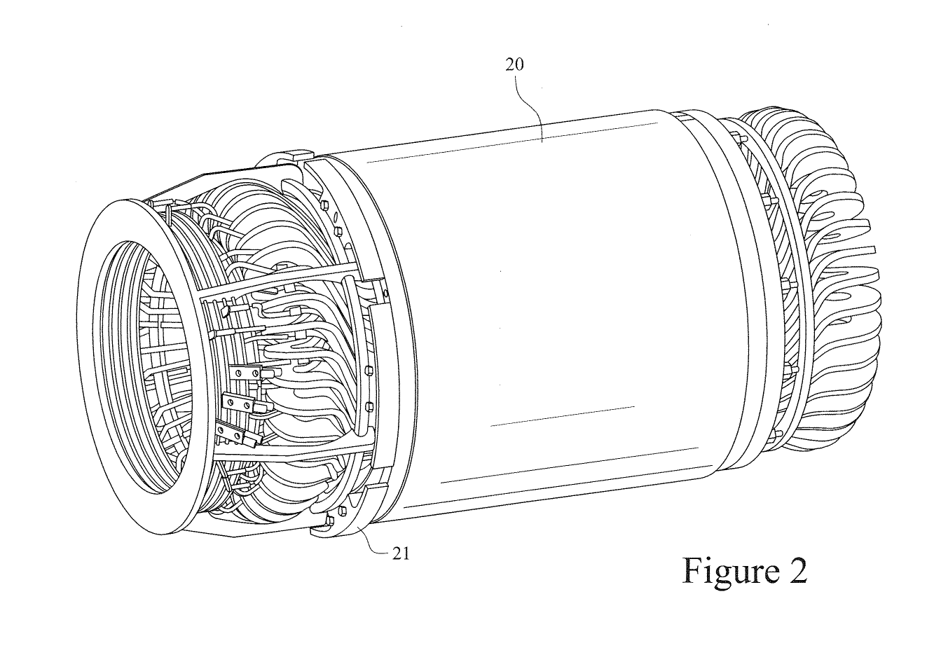

FIG. 1 depicts an exemplary embodiment of a pressurized gas cooled integrated motor-compressor unit. In FIG. 1 a pressure vessel is shown at 10 to include therein stator core 20 (shown in FIG. 2). Pressure vessel 10 includes inlets, outlets, bushings, plates, and connections for the necessary inputs and connections including; stator leads 11; stator instrumentation 12; gas inlet 13; gas outlet 14; and access opening plate 15 (cover plate not shown).

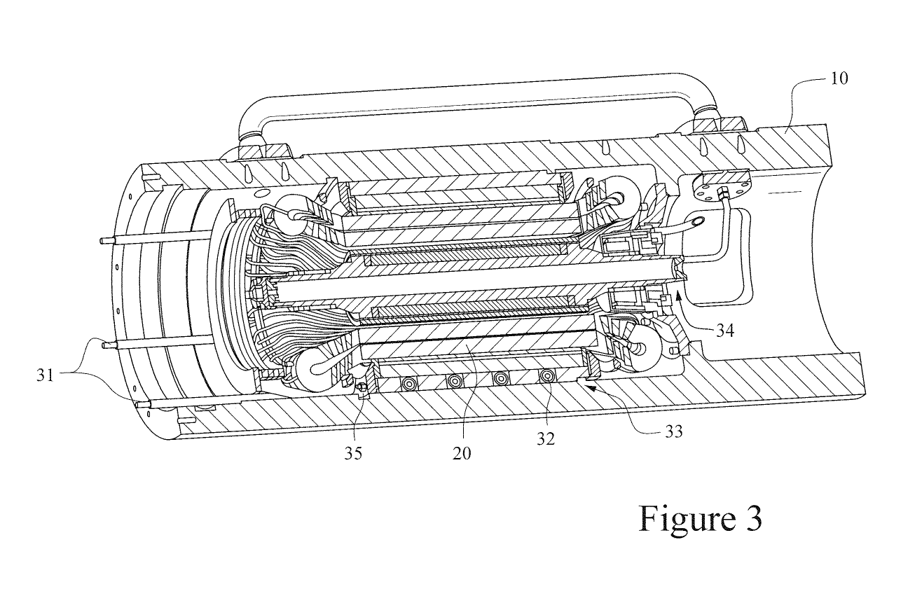

FIG. 2 shows wound stator core 20 fitted with axial retention devices 21. As will be described in greater detail below, axial retention devices 21 maintain the axial position of the stator core within the pressure vessel during transit and operating conditions. FIG. 3 shows the assembly of stator core 20 within pressure vessel 10. Tooling 31 is used to position stator core 20 within pressure vessel 10 which is facilitated by rollers 32. Shoulder 33 is formed into pressure vessel 10 for retaining the stator core in place and cooperates with axial retention devices 21 positioned within axial groove 35. As will be understood by those skilled in the art, rotor assembly 34 is disposed within stator core 20.

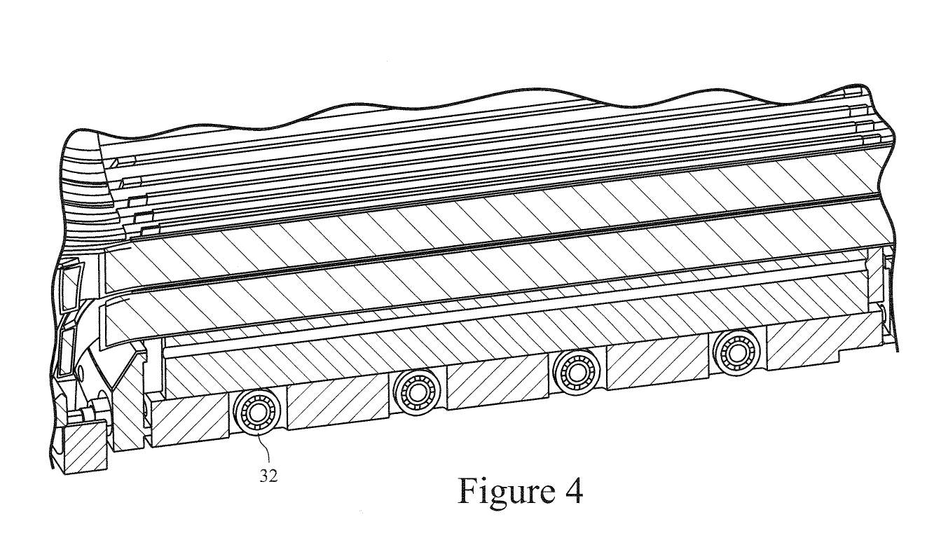

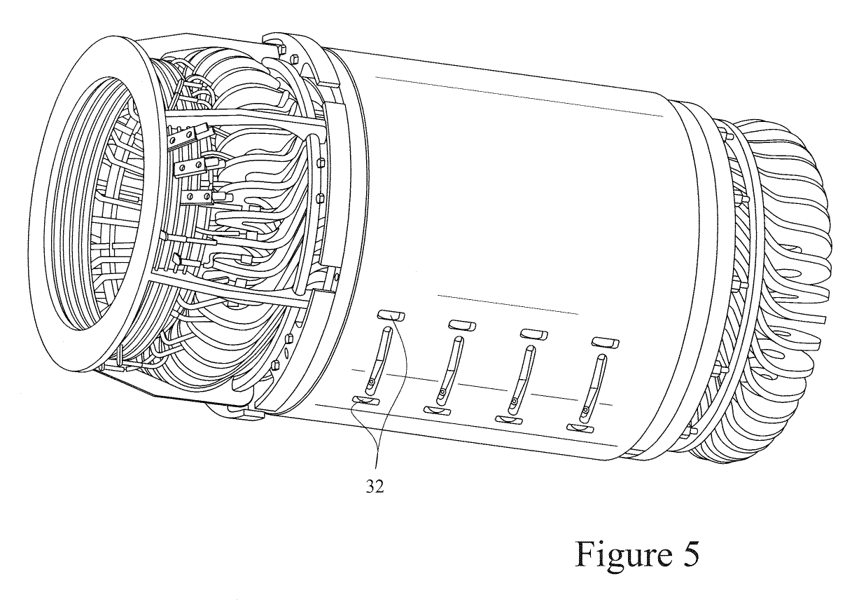

FIG. 4 shows, in greater detail, rollers 32 of the cross sectional view in FIG. 3 located at the bottom of stator core 20. FIG. 5 is a perspective view of rollers 32 at the bottom of stator core 20.

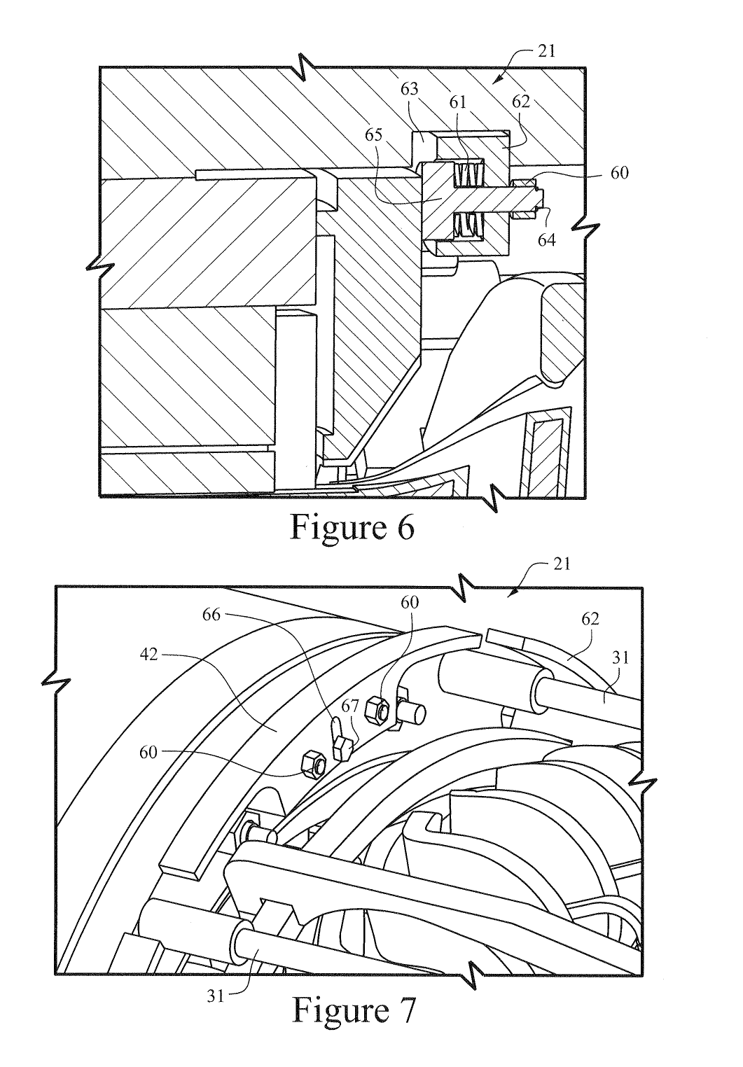

FIGS. 6 and 7 show axial retention devices 21 in greater detail which are provided for axially locking stator core 20 within pressure vessel 10. As shown in FIG. 6, prior to insertion of the rotor and stator, the nut 60 is tightened on the shaft of plunger 65 so as to compress spring washer 61 which is contained within carrier assembly 62. Initially, the carrier assemblies 62 are banded (not shown) to hold them radially inward.

After the rotor and stator are moved into position by tooling 31, the banding is removed. The carrier assemblies 62 then move radially into pressure vessel groove 35, as shown in FIG. 6. The nuts 60 are loosened to allow spring washers 61 to activate and snap rings 64 captivate the nuts. Once in position, the carrier assemblies 62 can be fixed in place by carrier bolts 67 (shown in FIG. 7) which are adjustable within radial slot 66.

FIG. 7 shows these axial locking structures in perspective, depicting carrier assemblies 62 as arc shaped with two nuts 60 and spring washers 61 (not shown) assembled on each arc shaped portion of carrier assembly 62. Also shown in FIG. 7 is tooling 31 for inserting and extracting the rotor and stator assembly. Tooling 31 comprises a series of threaded rods which mate with correspondingly threaded portions formed on the stator assembly. The rods can be connected at their other end to a plate or disk (not shown) to allow for even pressure to be applied when removing or inserting the stator assembly.

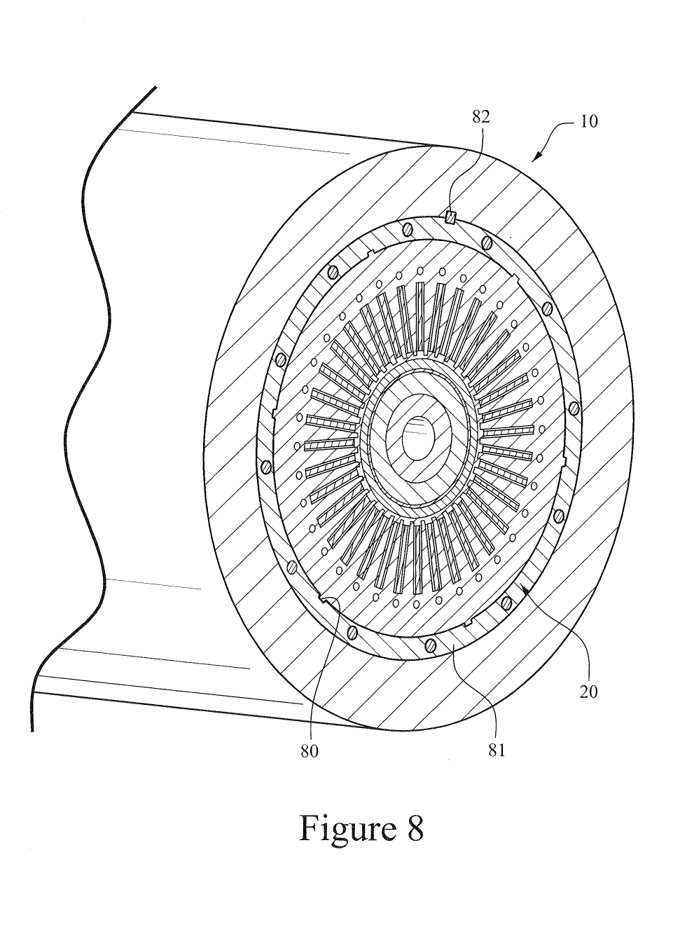

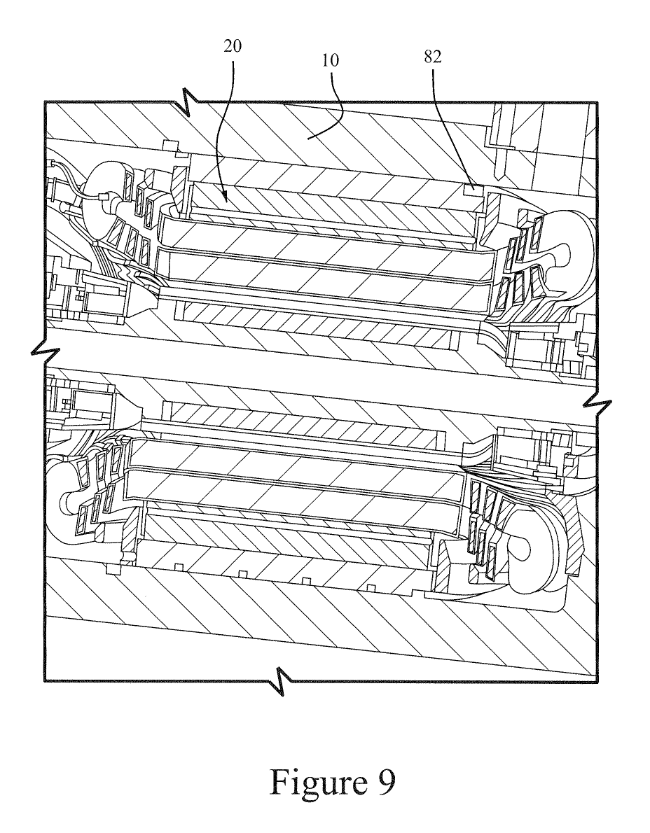

FIG. 8 shows in detail the key system for locking the angular position of stator core 20 within pressure vessel 10. A series of tabs 80 formed within the outer laminations of stator core 20 mate with corresponding indentations within an inner surface of outer sleeve 81 of the stator core 20. The indentations in outer sleeve 81 are slightly larger than the mating and corresponding tabs 80 to facilitate installation of the stator laminations to outer sleeve 81. A key 82, shown at the upper outer surface of sleeve 81 is positioned to angularly and fixedly position the stator core 20 within pressure vessel 10. As shown in FIG. 9, key 82 need not extend the entire longitudinal length of stator core 20.

While the invention has been described in connection with what is presently considered to be the most practical and preferred embodiment, it is to be understood that the invention is not to be limited to the disclosed embodiment, but on the contrary is intended to cover various modifications and equivalent arrangements included within the spirit and scope of the appended claims.

What is claimed:

1. A pressurized gas cooled high speed motor includes a stator and rotor assembled within a pressure vessel wherein the stator and rotor can be removed from the pressure vessel without disconnecting high pressure piping from the pressure vessel, the stator comprising a spring loaded axial retention mechanism that cooperates with a groove in the pressure vessel for maintaining the stator fixedly in place in the pressure vessel during transport and operation of the motor.

2. The motor claimed in claim 1 further comprising a shoulder formed in the pressure vessel for axially positioning the stator and rotor assembly within the pressure vessel.

3. The motor claimed in claim 2 further comprising a key for angularly positioning the stator within the pressure vessel.

4. The motor as in claim 2, wherein said stator includes a set of wheels at the bottom of the stator core.

5. The motor as in claim 3, wherein said stator and rotor assembly includes a set of wheels at the bottom of the stator core.

6. A pressurized gas cooled high speed motor includes a stator and rotor assembly within a pressure vessel wherein the stator and rotor assembly can be simultaneously removed from the pressure vessel without disconnecting high pressure piping from the pressure vessel, the stator and rotor assembly comprising a spring loaded axial retention mechanism that cooperates with a groove in the pressure vessel for maintaining the stator and rotor assembly fixedly in place in the pressure vessel during transport and operation of the motor.

7. The motor claimed in claim 6 further comprising a shoulder formed in the pressure vessel for axially positioning the stator and rotor assembly within the pressure vessel.

8. The motor claimed in claim 7 further comprising a key for angularly positioning the stator within the pressure vessel.

9. The motor claimed in claim 7 wherein said stator and rotor assembly includes a set of wheels at the bottom of the stator core.

10. The motor claimed in claim 8 wherein said stator and rotor assembly includes a set of wheels at the bottom of the stator core.
